(19) United States
(12) Patent Application Publication
(10) Pub. No.: US 2005/0107231 A1
(43) Pub. Date: May 19, 2005

(54) Method for printing images and text on a plant container

(75) Inventors: Gary L. Vollers, Northridge, CA (US); Don T. Uchiyama, Downey, CA (US)

Correspondence Address: HAHN LOESER & PARKS, LLP, One GOJO Plaza, Suite 300, AKRON, OH, 44311-1076, US

(73) Assignee: Productivity California, Inc.

(21) Appl. No.: 11/018,036

(22) Filed: Dec. 21, 2004

Related U.S. Application Data
(63) Continuation-in-part of application No. 10/361,118, filed on Feb. 10, 2003.

(51) Int. Cl. B31B 1/90

(52) U.S. Cl. 493/105

(57) ABSTRACT

A method of printing images and text on a plant container. Multilayer, multicolor images and text are printed on a moving web of heat sealable polymeric material. Preferably, the heat sealable polymeric material includes 15 weight per cent to 20 weight per cent talc and has a thickness less than 0.02 inches. A sidewall blank is cut from the web after the images and text are printed. A bottom blank is cut from a second web of heat sealable polymeric material. The sidewall blank is formed into an open container with side edges of the sidewall blank being overlapping and sealed to one another. The bottom blank is inserted into the bottom of the open container and is sealed to the sidewall blank forming an illustrated plant container.

This application is a continuation-in-part of co-pending application Ser. No. 10/361,118, filed Feb. 10, 2003.

### BACKGROUND OF THE INVENTION

This invention relates generally to plant containers and a method of making the plant containers and more particularly to illustrated polymeric plant containers having graphics and text thereon and a method for forming illustrated polymeric plant container having graphics and text thereon.

### SUMMARY OF THE INVENTION

In one aspect of the present invention, this is accomplished by providing a method for producing an illustrated plant container comprising the steps of: providing a first sheet of polymeric material; step for forming multilayer high resolution colored images and text on one side of the first sheet of polymeric material; cutting a blank from the first sheet of polymeric material, the blank having a top edge, a bottom edge, and two side edges; forming the blank into an open container, the blank side edges overlapping one another; providing a second sheet of polymeric material; cutting a second blank from the second sheet of polymeric material; forming the plant container by inserting the second blank into the open container, and attaching the second blank to the open container proximate the blank bottom edge.

In another aspect of the present invention, this is accomplished by providing a method for forming an illustrated plant container comprising the steps of: providing a first roll of polymeric material; unrolling the first roll of polymeric material; printing images and information on one side of a portion of the first roll of polymeric material; forming a blank by cutting the portion of the first roll of polymeric material having the printed images and text, the blank having a top edge, a bottom edge, two side edges and including at least a portion of the images and text; providing a second roll of polymeric material; cutting a bottom piece from the second roll of polymeric material; forming the blank into an open container with the side edges overlapping one another; attaching an inner surface of one side edge to an outer surface of the other side edge; placing the bottom piece into the open container proximate the blank bottom edge; and attaching the bottom piece to the open container.

In another aspect of the present invention, this is accomplished by providing a method for forming an illustrating plant container comprising the steps of: providing a first roll of polymeric material containing about 15 weight per cent to 20 weight per cent mineral filler and having a thickness less than about 0.03 inch; unrolling the first roll of polymeric material; printing images and text on one side of a portion of the first roll of polymeric material using at least a 150 line screen by: printing one color and drying said one color; and repeating the steps of printing one color and drying said one color using another color until the images and text are printed in multiple colors, the surface of the first roll of printed material being in motion when the images and text are printed on said surface; placing a protective coating over the images and text; forming a blank by cutting the portion of the first roll of polymeric material having the printed images and text, the blank having a top edge, a bottom edge and two side edges, the blank including at least a portion of the images and text; providing a second roll of polymeric material; cutting a bottom piece from the second roll of polymeric material; forming the blank into an open container with the side edges overlapping one another; attaching an inner surface of one side edge to an outer surface of the other side edge; placing the bottom piece into the open container proximate the blank bottom edge; and attaching the bottom piece to the open container.

In another aspect of the present invention, this is accomplished by providing an illustrated plant container comprising: a heat sealable polymeric sidewall having a top edge, a bottom edge, two side edges, and multilayer, multicolor images and text on one surface thereof, the sidewall being formed into an open container with the side edges overlapping one another; and a bottom attached to the sidewall proximate the sidewall bottom edge, thereby forming a closed wall plant container.

In another aspect of the present invention, this is accomplished by providing an illustrated plant container comprising: a heat sealable polymeric sidewall having a top edge, a bottom edge, two side edges, a thickness less than about 0.03 inches, and multilayer, multicolor images and text on one surface thereof, the multilayer, multicolor images and text having a resolution of at least 150 lines per inch, each layer of the multilayer, multicolor images and text comprising a different color, the polymeric sidewall containing a mineral filler in an amount about 15 weight per cent to about 20 weight per cent, the sidewall being formed into an open container with the side edges overlapping one another; and a bottom attached to the sidewall proximate the sidewall bottom edge, thereby forming a closed wall plant container.

The foregoing and other aspects will become apparent from the following detailed description of the invention when considered in conjunction with the accompanying drawing figures.

### BRIEF DESCRIPTION OF THE DRAWING FIGURES

FIG. 1 is a perspective view of a plant container according to the present invention;

FIG. 2 is a plan view of a first embodiment of a sidewall for the plant container shown in FIG. 1;

FIG. 2A is a plan view of the sidewall shown in FIG. 2, illustrating one step in the formation of the sidewall;

FIG. 3 is a plan view of a second embodiment of a sidewall for the plant container shown in FIG. 11

FIG. 4 is a plan view of a bottom piece for the plant container shown in FIG. 1;

FIG. 4A is a plan view of the bottom piece shown in FIG. 4, illustrating one step in the formation of the bottom piece;

FIG. 5 is a perspective view of the bottom piece shown in FIG. 4, showing the skirt extending in a downward direction;

FIG. 6 is a partial cross-sectional view of the attachment of the bottom piece with the sidewall shown in FIG. 2;

FIG. 7 is a partial cross-sectional view of the attachment of the bottom piece with the sidewall shown in FIG. 3;

FIG. 8 is a plan view of the sidewall shown in FIG. 2 illustrating the multilayer, multicolor images and text formed on one side of the sidewall; and

FIG. 9 is a perspective view of the plant container shown in FIG. 1 illustrating the multilayer, multicolor images and text formed on one surface of the plant container.

### DETAILED DESCRIPTION

An embodiment of the plant container 10 shown in the FIGURES is formed from a sidewall 21 and a bottom 41. The sidewall 21 is formed into a tapered cylinder with an open top and an open bottom. Side edges 26, 28 form an overlapping seam 14. Preferably, sidewall 21 is formed from a heat sealable material and the side edges 26, 28 are heat sealed to form seam 14. More preferable, sidewall 21 is formed from a heat sealable polymeric material, and most preferably is formed from polyethylene.

Plant container 10 has a plurality of apertures 30 formed in the lower edge of the sidewall 21. In addition, bottom 41 includes a plurality of drain holes 42 and is positioned a predetermined distance from the lower edge 24 of sidewall 21. The combination of the bottom 41 being positioned above the bottom edge 24 and the apertures 30 permits water to drain away from the interior of plant container 10 and allows air to enter through apertures 30. This will reduce damage to plant roots caused by retention of excess water in plant container 10.

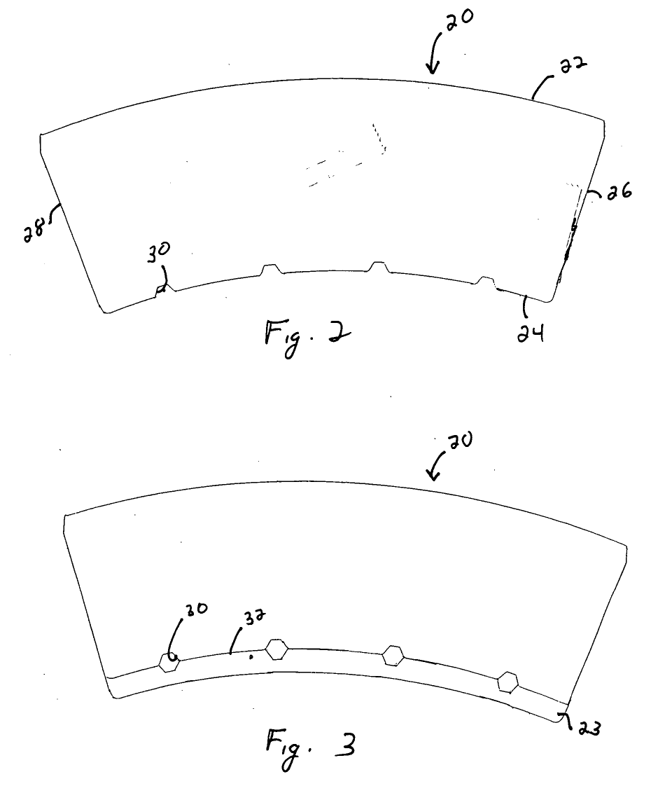

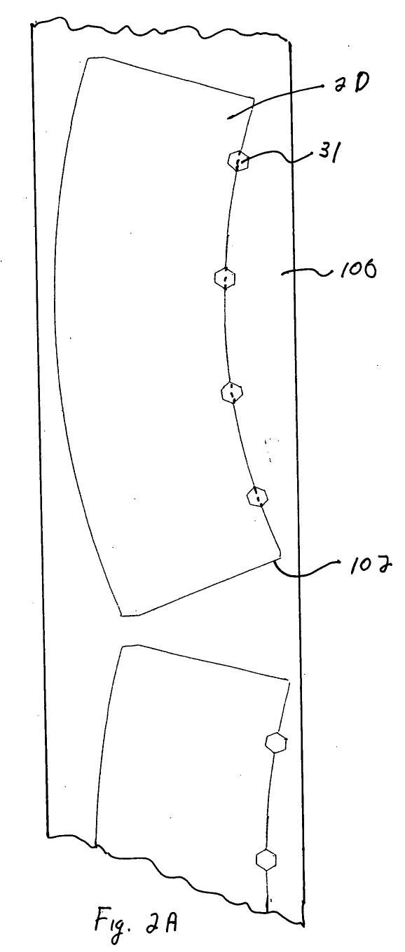

FIGS. 2 and 3 show two embodiments of sidewall blanks 20 used to form sidewall 21. Sidewall blank 20 has an arcuate shape with a curved top or upper edge 22 and a concentric curved bottom or lower edge 24. Extending between the top and bottom edges, 22, 24 are side edges 26, 28. A plurality of apertures 30 are formed in or adjacent to lower edge 24. In the embodiment shown in FIG. 2, the apertures 30 are formed in lower edge 24.

In the embodiment shown in FIG. 3, the apertures 30 are spaced slightly from lower edge 24. A score line 32 extending through the apertures is formed in the sidewall blank 20. The area between the score line 32 and the lower edge 24 forms an overlap 23.

FIG. 2A illustrates one step in the formation of sidewall blank 20. Sidewall blank 20 is formed from a web of flat sheet material 100. Preferably, web 100 is provided as a roll of polymeric material. First, a plurality of holes 31 are formed in web 100. Sidewall cut line 102 is shown in FIG. 2A to show the relationship of the holes 31 relative to the outline of sidewall blank 20. After holes 31 are cut, web 100 is cut along line 102 to form sidewall blank 20. FIG. 2A illustrates the formation of the sidewall blank 21 shown in FIG. 2. When sidewall blank 20 shown in FIG. 3 is being formed, holes 31 would be spaced further from the lower edge of cut line 102. In addition to cutting sidewall blank 20 from web 102, a score line 32 would also be formed in sidewall blank 20.

In one embodiment, web 100 is polypropylene or polyethylene containing 15% to 20% 300 mesh talc, chalk or calcium. The calcium can be in the form of calcium carbonate.

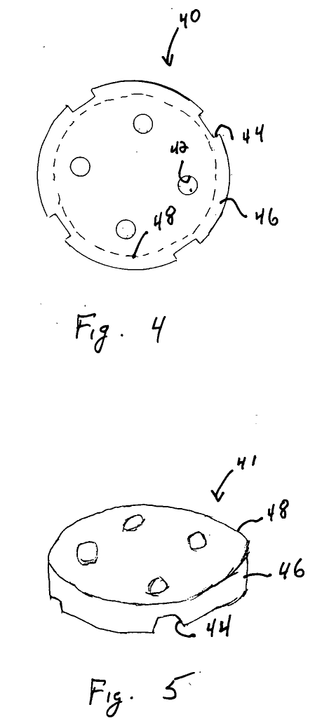

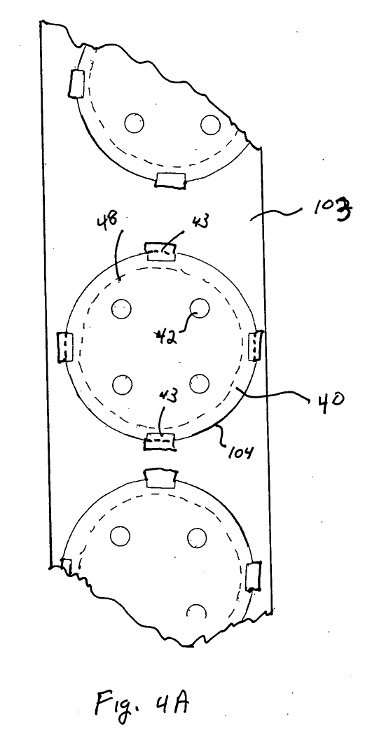

The bottom 41 of plant container 10 is formed from a bottom blank 40, as shown in FIGS. 4 and 5. Preferably, bottom blank 40 is circular having a plurality of drain holes 42 formed in a central portion of the bottom blank 40. An outer peripheral area of the bottom blank 40 forms a skirt 46. A plurality of spaced apart notches 44 are formed in the skirt 46. Preferably, notches 44 correspond in number, size and placement with apertures 30.

FIG. 4A illustrates one step in the formation of bottom blank 40. Bottom blank 40 is formed from a web of flat sheet material 103. Preferably, web 103 is provided as a roll of polymeric material. First, a plurality of drain holes 42 and holes 43 are formed in web 103. Bottom blank cut line 104 is shown in FIG. 4A to show the relationship of the drain holes 42 and holes 43 relative to the outline of bottom blank 40. Cut line 104 extends through holes 43. After drain holes 42 and holes 43 are cut, web 103 is cut along line 104 to form bottom blank 40. Notches 44 are formed when bottom blank 41 is cut from web 103. After bottom blank 40 is cut from web 103, the bottom blank 40 is pressed into a saucer shape as shown in FIG. 5. Dotted line 48 shows the division between the central portion of bottom blank 40 and the skirt 46. Notches 44 are positioned in a lower edge of skirt 46.

In one embodiment, web 103 is polypropylene or polyethylene containing 40% to 50% 300 mesh talc, chalk or calcium. The calcium can be in the form of calcium carbonate.

The thickness of sidewall 21 and bottom 41 can be from 0.005 to 0.030 inches, Preferably, the bottom 41 thickness is 0.010 inches and the sidewall 21 thickness is between 0.016 and 0.020 inches.

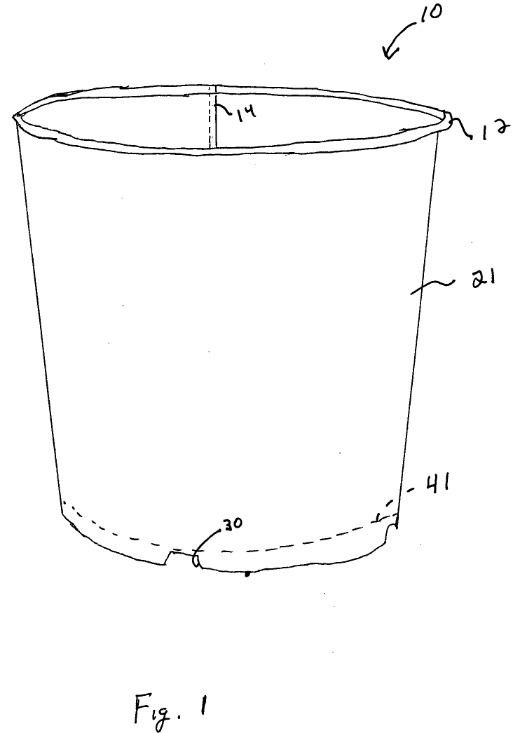

After sidewall blank 20 has been formed from web 100, sidewall blank 20 is formed into a tapered cylinder, as shown in FIG. 1. In one embodiment, an outer surface of one side edge and an inner surface of the other side edge are heated. As the tapered cylinder is formed, the heated surfaces are pressed together to seal the side edges at overlapping seam 14. Similarly, the outer surface of skirt 46 and the inner surface of sidewall blank 20 proximate lower edge 24 are heated. Bottom 41 is positioned within the tapered cylinder and the heated surfaces are pressed together to seal the bottom 41 to the tapered cylinder. As bottom 41 is positioned within the tapered cylinder, notches 44 are aligned to be at least partially overlapping with apertures 30.

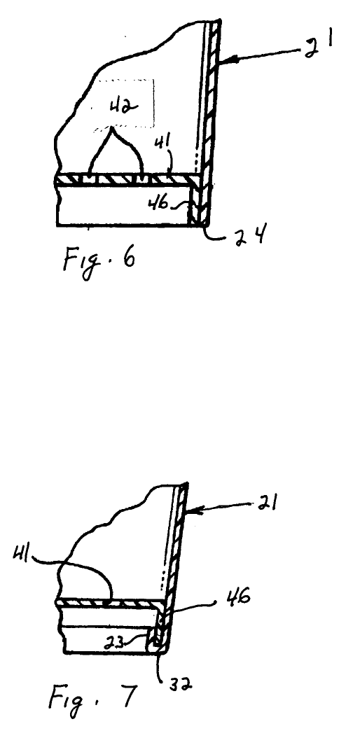

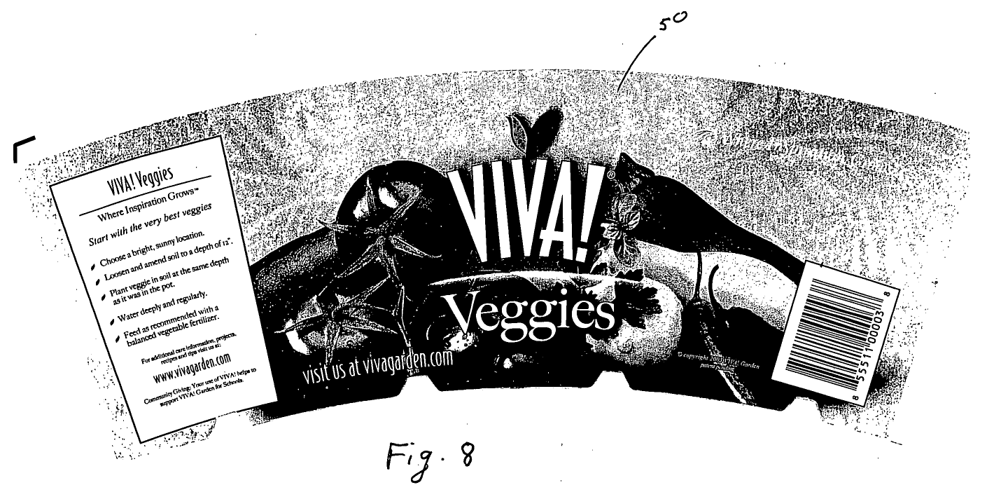

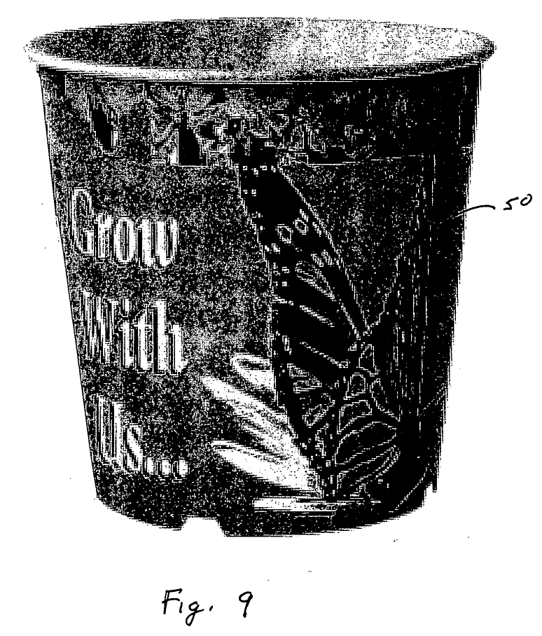

When the sidewall blank 20 shown in FIG. 2 is used, the bottom 41 and the sidewall 21 are aligned as shown in FIG. 6. When the sidewall blank 20 shown in FIG. 3 is used, the bottom 41 and the sidewall 21 are aligned as shown in FIG. 7. As the sidewall blank 20 is formed into the tapered cylinder, the lower portion of the sidewall blank 20 is turned or folded along score line 32 so that bottom skirt 46 fits between the overlapping portion 23 of sidewall blank 20 and the adjacent inner surface of sidewall blank 20 as shown in FIG. 7.

Sidewall blank 20 can have other shapes in addition to the arcuate shape shown in FIGS. 2 and 3. For example, if sidewall blank 20 were rectangular, a non-tapered cylindrical plant container 10 could be formed. Other shapes could be used to form a non-round plant container 10.

To form the tapered cylinder plant container 10 shown in FIG. 1, web 100 is provided, preferably in the form of a roll of heat sealable material. A plurality of spaced apart holes 31 are cut in web 100. Then, an arcuate sidewall blank 20 is cut from web 100 along cut line 102. The lower edge 24 of sidewall blank 20 either extends through holes 31, as shown in FIG. 2, or is proximate holes 31, as shown in FIG. 3.

Web 103 is provided, also preferably in the form of a roll of heat sealable material. A plurality of drain holes 42 and holes 43 are cut in web 103. Bottom blank 40 is cut from web 103 along cut line 104. Next, bottom blank 40 is pressed into bottom 41 forming downwardly extending skirt 46. The steps of forming sidewall blank 20 and bottom 41 may be performed simultaneously depending upon the machines being used.

Side edges 26, 28 of arcuate sidewall blank 20 are then heated. Preferably, the inner surface of one edge and the outer surface of the other edge only are heated. Sidewall blank 20 is then formed into an open tapered cylinder. The heated edges are pressed together to form overlapping seam 14. The upper edge 22 of sidewall blank 20 is rolled to form rolled rim 12.

The inner surface sidewall blank 20 adjacent lower edge 24 and the outer surface edge of skirt 46 are heated. Bottom 41 is inserted into the open lower end of the tapered cylinder. As bottom 41 is inserted into the open lower end of the tapered cylinder, notches 44 are aligned with apertures 30. The lower portion of sidewall 21 and bottom 41 are pressed together to seal bottom 41 and sidewall 21 together. Preferably, bottom 41 is positioned a predetermined distance from the lower edge 24 of sidewall 21.

A machine similar to a PCM1002 or a PMC1300NR by Paper Machinery Corporation can be used to manufacture plant container 10.

Preferably, plant container 10 has high quality graphics or images, and text 50 on the outside of the container 10 as shown in FIGS. 8 and 9.

The images and text 50 are formed by printing multicolor images and text using flexographic or screen printing. Preferably, the multicolor images and text are formed using a four color process (three colors plus black). However, a three color process can be used. The images and text are preferably printed using at least a 150 line flexographic printer. The first color is printed and dried before applying the second color, which is then dried before printing the third color. If a four color process is used, the third color is dried before applying the fourth color. The multiple layers of colors form the multicolor images and text.

In a preferred embodiment, after the last color layer has dried, a protective coating is applier over the multiple layers of colors. Preferably, the protective coating is an automotive varnish.

Preferably, the images and text 50 are printed on the polymeric material or web while the web is in motion.

The preferred method of forming the illustrated plant container 10 uses rolls of polymeric material to form the sidewalls 21. A roll of polymeric material is unrolled and moved through a printer. In the printer, the images and text 50 are printed on the polymeric material. A single printer with multiple print stations can be used. Or, alternatively, separate printers for each color can be used. The images and text 50 have a resolution of at least 100 lines per inch. Preferably, the images and text 50 have a resolution of at least 150 lines per inch.

After the images and text 50 for a plant container 10 have been printed, sidewall blank 20 is cut from the roll or web of polymeric material 100. As needed, the sidewall blank 20 can contain all of the images and text 50, or at least a portion of the images and text 50. Preferably, the images and text 50 are printed on the roll of polymeric material before the sidewall blank 20 is cut out. Alternatively, sidewall blank 20 can be cut from the roll of polymeric material and then the images and text 50 printed on the sidewall blank 20.

In a preferred embodiment, the web of polymeric material includes between about 10 weight per cent and about 25 weight per cent mineral filler and is less than 0.03 inches thick. More preferably, the mineral filler is between about 15 weight per cent and 20 weight per cent and the thickness is less than about 0.02 inches. The mineral filler comprises talc, chalk, calcium, or a combination thereof. Preferably, the mineral filler is 300 mesh and is talc.

Prior to printing the images and text 50 on the polymeric material, the polymeric material may be corona treated.

1. A method for producing an illustrated plant container comprising the steps of:
providing a first sheet of polymeric material;
step for forming multilayer high resolution colored images and text on one side of the first sheet of polymeric material;
cutting a blank from the first sheet of polymeric material, the blank having a top edge, a bottom edge, and two side edges;
forming the blank into an open container, the blank side edges overlapping one another;
providing a second sheet of polymeric material;
cutting a second blank from the second sheet of polymeric material; and
forming the plant container by inserting the second blank into the open container, and attaching the second blank to the open container proximate the blank bottom edge.

2. The method according to claim 1, wherein the step of providing a first sheet of polymeric material comprises providing a sheet of polymeric material containing a mineral filler in an amount of about 10 weight per cent to about 25 weight per cent.

3. The method according to claim 2, wherein the step of providing a sheet of polymeric material containing a mineral filler in an amount of about 10 weight per cent to about 25 weight per cent comprises providing a sheet of polymeric material containing a mineral filler selected from the group consisting of calcium carbonate, talc, chalk or combinations thereof.

4. The method according to claim 1, wherein the step of providing a first sheet of polymeric material comprises providing a sheet of polymeric material containing a mineral filler in an amount of about 15 weight per cent to about 20 weight per cent.

5. The method according to claim 1, wherein the step for forming images and text comprises printing using at least a 150 line screen.

6. The method according to claim 1, wherein the step of providing a first sheet of polymeric material comprises providing a sheet of polypropylene.

7. The method according to claim 1, further comprising the step of:
placing a protective coating over the images and text.

8. The method according to claim 1, wherein the step of cutting a blank from the first sheet of polymeric material occurs before the step for forming images and text.

9. The method according to claim 1, wherein the step of cutting a blank from the first sheet of polymeric material occurs after the step for forming images and text, the blank including at least a portion of the images and text.

10. The method according to claim 1, wherein the step for forming images and text comprises printing one color; and drying said one color, and repeating the steps of printing one color; and drying said one color using another color until the images and text are printed in multiple colors.

11. The method according to claim 10, wherein the steps of printing comprises at least one of flexographic printing and screen printing.

12. The method according to claim 1, wherein the step for forming images and text comprises printing on the first sheet of polymeric material while the first sheet of polymeric material is moving.

13. A method for forming an illustrated plant container comprising the steps of:
providing a first roll of polymeric material;
unrolling the first roll of polymeric material;
printing images and text on one side of a portion of the first roll of polymeric material;
forming a blank by cutting the portion of the first roll of polymeric material having the printed images and text, the blank having a top edge, a bottom edge, two side edges and including at least a portion of the images and text;
providing a second roll of polymeric material;
cutting a bottom piece from the second roll of polymeric material;
forming the blank into an open container with the side edges overlapping one another;
attaching an inner surface of one side edge to an outer surface of the other side edge;
placing the bottom piece into the open container proximate the blank bottom edge; and
attaching the bottom piece to the open container.

14. The method according to claim 13, wherein the step of printing images and text comprises printing one color; and drying said one color, and repeating the steps of printing one color; and drying said one color using another color until the images and text are printed in multiple colors.

15. The method according to claim 13, further comprising the step of:
applying a protective coating to the images and text.

16. The method according to claim 13, wherein the step of providing a first roll of polymeric material comprises providing a roll of polymeric material containing about 15 weight per cent to 20 weight per cent mineral filler and having a thickness less than about 0.03 inch.

17. The method according to claim 13, wherein the step of images and text comprises printing on the first roll of polymeric material while the first roll of polymeric material is moving.

18. A method for forming an illustrating plant container comprising the steps of:
providing a first roll of polymeric material containing about 15 weight per cent to 20 weight per cent mineral filler and having a thickness less than about 0.03 inch;
unrolling the first roll of polymeric material;
printing images and text on one side of a portion of the first roll of polymeric material using at least a 150 line screen by: printing one color and drying said one color; and repeating the steps of printing one color and drying said one color using another color until the images and text are printed in multiple colors, the surface of the first roll of polymeric material being in motion when the images and text are printed on said surface;
placing a protective coating over the images and text;
forming a blank by cutting the portion of the first roll of polymeric material having the printed images and text, the blank having a top edge, a bottom edge and two side edges, the blank including at least a portion of the images and text;
providing a second roll of polymeric material;
cutting a bottom piece from the second roll of polymeric material;
forming the blank into an open container with the side edges overlapping one another;
attaching an inner surface of one side edge to an outer surface of the other side edge;
placing the bottom piece into the open container proximate the blank bottom edge; and
attaching the bottom piece to the open container.

19. An illustrated plant container comprising:
a heat sealable polymeric sidewall having a top edge, a bottom edge, two side edges, and multilayer, multicolor images and text on one surface thereof, the sidewall being formed into an open container with the side edges overlapping one another; and
a bottom attached to the sidewall proximate the sidewall bottom edge, thereby forming a closed wall plant container.

20. The illustrated plant container according to claim 19, wherein the heat sealable polymeric sidewall has a thickness less than about 0.03 inches.

21. The illustrated plant container according to claim 20, wherein the heat sealable polymeric sidewall has a thickness less than about 0.02 inches.

22. The illustrated plant container according to claim 20, wherein the heat sealable polymeric sidewall includes a mineral filler in an amount of about 10 weight per cent to about 25 weight per cent.

23. The illustrated plant container according to claim 22, wherein the heat sealable polymeric sidewall includes a mineral filler in an amount of about 15 weight per cent to about 20 weight per cent.

24. The illustrated plant container according to claim 22, wherein the mineral filler is at least one of talc, chalk or calcium carbonate.

25. The illustrated plant container according to claim 22, wherein the mineral filler is at least 300 mesh.

26. The illustrated plant container according to claim 19, wherein the images and text have a resolution of at least 150 lines per inch.

27. The illustrated plant container according to claim 19, wherein each layer of the multilayer, multicolor images and text comprises a different color.

28. The illustrated plant container according to claim 27, further comprising:
a protective layer on the images and text.

29. An illustrated plant container comprising:
a heat sealable polymeric sidewall having a top edge, a bottom edge, two side edges, a thickness less than about 0.03 inches, and multilayer, multicolor images and text on one surface thereof, the multilayer, multicolor images and text having a resolution of at least 150 lines per inch, each layer of the multilayer, multicolor images and text comprising a different color, the polymeric sidewall containing a mineral filler in an amount about 15 weight per cent to about 20 weight per cent, the sidewall being formed into an open container with the side edges overlapping one another; and
a bottom attached to the sidewall proximate the sidewall bottom edge, thereby forming a closed wall plant container.
